(19) United States
(12) Patent Application Publication
(10) Pub. No.: US 2023/0191639 A1
(43) Pub. Date: Jun. 22, 2023

(54) POWER TOOL AND PROTECTING COVER THEREFOR

(71) Applicant: Techtronic Cordless GP, Anderson, SC (US)

(72) Inventors: GONG MENG SHU, Dongguan City (CN); Da Zheng LI, Dongguan City (CN); Xiang Hua Zhang, Dongguan City (CN)

(21) Appl. No.: 18/082,805

(22) Filed: Dec. 16, 2022

(30) Foreign Application Priority Data
Dec. 20, 2021 (CN) CN 202123232074.2

(51) Int. Cl. B26B 29/00; B26B 15/00

(52) U.S. Cl. CPC B26B 29/00; B26B 15/00

(57) ABSTRACT

According to the present utility model, there are provided a power tool and a protecting cover. The protecting cover includes a first cover body and a second cover body that are pivotably connected to enable movement between an open position and a closed position. Engagement mechanisms configured to enable the protecting cover to be removably fixed on the tool body are provided on an outer sidewall of the tool body and an inner sidewall of the first cover body. The protecting cover according to the present utility model can be easily and conveniently installed on the body of the power tool; the protecting cover itself has high intensity, which is not prone to deformation after long-term use; and the protecting cover can receive therein accessories for replacing a working part to thus provide more convenience to the user.

### TECHNICAL FIELD

The present utility model relates to the field of small work equipment, in particular a power tool and a protecting cover.

### BACKGROUND

On the market are currently available power tools with a working part, such as electric scissors, some of which have a protecting cover covering a cutter. The protecting cover is typically designed in a sleeve-like structure, which can be wholly sleeved onto or removed from the power tool along a direction substantially parallel to an extension direction of the cutter. Such protecting cover has a common problem of poor engagement with the body of the cutter or the power tool and probably separating undesirably from the power tool. In addition, those protecting covers exhibit a poor performance in intensity and are prone to deformation after long-term use. Further, the protecting covers are monotonous in application, not diversified.

As such, there is a need for a power tool and a protecting cover thereof, so as to at least partly solve the above problem.

### SUMMARY

The objective of the present utility model is to provide a power tool and a protecting cover. The protecting cover according to the present utility model can be easily and conveniently installed on a body of the power tool, and there may be multiple types of connection relations between the protecting cover and the tool body to fix them relative to each other so that the protecting cover and the tool body, particularly the cutter, in an installed state, can engage firmly and conveniently and prevent releasing of the protecting cover. In addition, the protecting cover according to the present utility model per se has high intensity, which is not prone to deformation after long-term use. Further, the protecting cover can receive therein accessories for replacing a working part to thus provide more convenience to the user.

According to one aspect of the present utility model, there is provided with a power tool, comprising:

a tool body provided with a working part protruding outwards;

a protecting cover comprising a first cover body and a second cover body, the first cover body and the second cover body being pivotably connected to enable movement between an open position and a closed position, the first cover body and the second cover body jointly defining a receiving space for receiving the working part when being in the closed position, and a retaining member being provided at an end of the first cover body and the second cover body away from a pivot connection position, the retaining member being configured to retain the first cover body and the second cover body in the closed position,

wherein engagement mechanisms mating with each other and configured to enable the protecting cover to be removably fixed on the tool body are formed on an outer sidewall of the tool body and an inner sidewall of the first cover body.

In an implementation, the engagement mechanisms comprise a pin disposed on one of the inner sidewall of the first cover body and the outer sidewall of the tool body, and a recessed hole disposed on the other one of the inner sidewall of the first cover body and the outer sidewall of the tool body.

In an implementation, the engagement mechanisms comprise a pin disposed on the inner sidewall of the first cover body and a recessed hole on the outer sidewall of the tool body, wherein:

the pin has a cross-shaped section;

the tool body comprises at least two housing components assembled together via a screw, and a screw hole on one of the housing components for receiving the screw also acts as the recessed hole.

In an implementation, an inner sidewall of at least one of the first cover body and the second cover body is provided with a rib, and an outer contour of the rib and an outer contour of the working part at least partly form-fit so that the rib prevents the working part from being released from the protecting cover when the protecting cover is in place to cover the working part.

In an implementation, the rib comprises a first rib and a second rib disposed opposite to each other, and the working part is a cutter comprising a stationary blade and a movable blade pivotable relative to each other, a stationary blade feature outer contour of the stationary blade away from the movable blade is partly form-fit with the first rib, and a movable blade feature outer contour of the movable blade away from the stationary blade is partly form-fit with the second rib.

In an implementation, the stationary blade feature outer contour is a convex arc contour, and the movable blade feature contour is a concave arc contour.

In an implementation, the stationary blade is fixed relative to the tool body, the movable blade is pivotable relative to the stationary blade between a first limit position and a second limit position, and the power tool is configured to retain the movable blade in the first limit position when operation is stopped, and the second rib is positioned to mate with the movable blade feature outer contour when the movable blade is in the first limit position.

In an implementation, the power tool is configured to allow a user to remove and replace the working part using tool accessories, and the receiving space further comprises a space for receiving the tool accessories.

In an implementation, an inner sidewall of the second cover body is provided with a magnet protruding towards the working part, and the magnet is positioned in such a manner that the magnet is attached to the working part when the protecting cover is in place to cover the working part.

In an implementation, the retaining member comprises locking mechanisms mating with each other and respectively disposed on the first cover body and the second cover body.

According to another aspect of the present utility model, there is provided a protecting cover of a power tool comprising a tool body having a working part extending outwards, characterized in that, the protecting cover comprises a first cover body and a second cover body that are pivotably connected to enable movement between an open position and a closed position, and the first cover body and the second cover body jointly define a receiving space for receiving the working part when being in the closed position, and a retaining member is provided at an end of the first cover body and the second cover body away from a pivot connection position, the retaining member being configured to retain the first cover body and the second cover body in the closed position,

wherein an inner sidewall of the first cover body is provided with an engagement mechanism engaging an outer sidewall of the tool body, and the engagement mechanism being configured to enable the protecting cover to be removably fixed on the tool body.

In an implementation, the engagement mechanism comprises a pin.

In an implementation, the pin has a cross-shaped section.

In an implementation, an inner sidewall of at least one of the first cover body and the second cover body is provided with a rib, and an outer contour of the rib and an outer contour of the working part at least partly form-fit to prevent the working part from being released from the protecting cover when the protecting cover is in place to cover the working part.

In an implementation, the rib comprises a first rib and a second rib that at least partly form-fit with the working part, respectively.

In an implementation, the receiving space further comprises a space for receiving tool accessories for removing and replacing the working part.

In an implementation, an inner sidewall of the second cover body is provided with a protruding magnet that is positioned in such a manner that the magnet is attached to the working part when the protecting cover is in place to cover the working part.

In an implementation, the retaining member includes locking mechanisms mating with each other and respectively disposed on the first cover body and the second cover body.

### BRIEF DESCRIPTION OF THE DRAWINGS

For the sake of better understanding on the above and other objectives, features, advantages, and functions of the present utility model, the preferred implementations are provided with reference to the drawings. The same reference signs refer to the same components throughout the drawings. It is to be understood by those skilled in the art that the drawings are merely provided to illustrate preferred implementations of the present utility model, without suggesting any limitation to the protection scope of the present utility model, and respective components therein are not necessarily drawn to scale.

FIG. 1 is a front view of a power tool according to a preferred implementation of the present utility model;

FIG. 2 is a rear view of the structure in FIG. 1;

FIG. 3 is a rear view of a tool body of the power tool in FIG. 1, where a protecting cover is removed; and

FIG. 4 is a three-dimensional view of the protecting cover in FIG. 1 as observed from an approximate front angle.

### REFERENCE SIGNS

100 power tool
10 tool body
11 gripping portion
12 cutter
101 trigger portion
121 stationary blade
122 movable blade
13 pivot
14 recessed hole
121a stationary blade feature outer contour
121b blade edge of stationary blade
122a movable blade feature outer contour
122b blade edge of movable blade
200 protecting cover
210 first cover body
220 second cover body
215, 225 first rib
216, 226 first reinforcing rib
217, 227 first connecting rib position
211, 221 second rib
212, 221 second reinforcing rib
213, 223 second connecting rib position
214 protrusion
224 hook portion
224a hook
228a magnet slot

### DETAILED DESCRIPTION OF IMPLEMENTATIONS

Reference now will be made to the drawings to describe in detail implementations of the present utility model. What will be described herein will only cover preferred implementations of the present utility model, based on which those skilled in the art would envision other possible manners which also fall into the scope described herein.

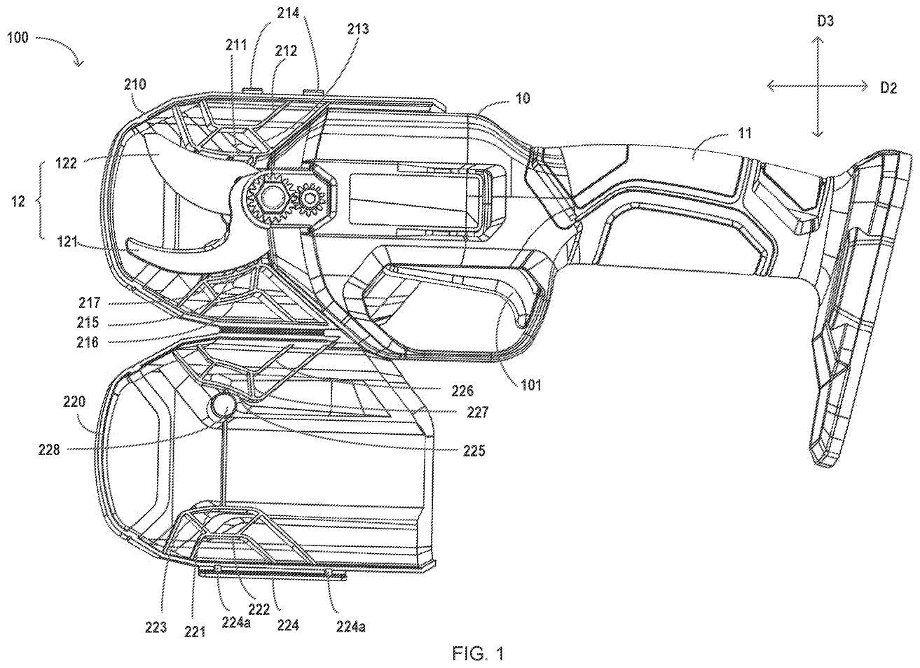

FIGS. 1-4 illustrate preferred implementations of the power tool and the protecting cover according to the present utility model. It is worth nothing that the direction and position terms described here are to be read as relative directions and positions, rather than absolute directions and positions. The direction and position terms described here may be interpreted with reference to the example structures as shown in FIGS. 1-4.

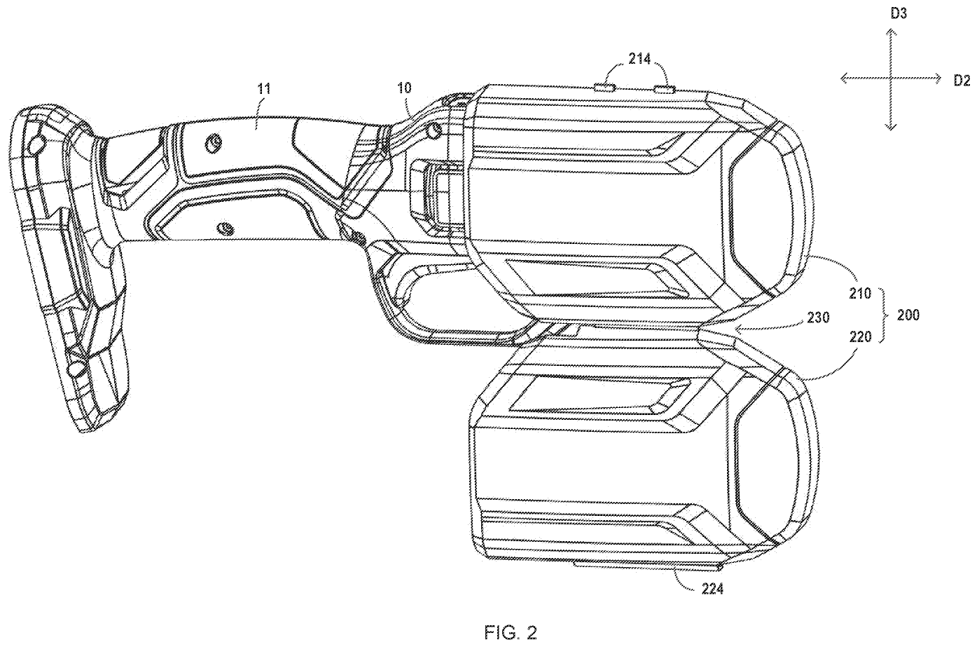

Referring now to FIGS. 1 and 2, in a preferred implementation, a power tool 100 includes a tool body 10 and a protecting cover. The tool body 10 is provided with a working part protruding outwards. The working part shown in the drawings is a cutter 12, which may also be other operation tools. More specifically, in the present implementation, for ease of description, a closing direction of the protecting cover is defined as a first direction, and the tool body 10 substantially forms a planar structure extending within a plane (which is called feature plane) defined by a second direction D2 extending along a longitudinal direction of the tool body, and a third direction D3 perpendicular to the second direction. It would be appreciated that the first direction, the second direction D2 and the third direction D3 are orthogonal to one another in space. Wherein, the tool body 10 further includes a gripping portion 11 that forms a strip structure extending substantially along the second direction D2, and the cutter 12 forms a blade extending along the feature plane. The tool body 10 is provided thereon with a trigger portion 101.

The protecting cover includes a first cover body 210 and a second cover body 220. The first cover body 210 and the second cover body 220 are pivotably connected to enable pivoting movement relative to each other between an open position and a closed position. FIGS. 1, 2 and 4 are views when the first cover body 210 and the second cover body 220 are in the open position. When being in the closed position, the first cover body 210 and the second cover body 220 jointly define a receiving space for receiving the cutter 12 of the power tool 100. When the first cover body 21 and the second cover body 220 are in the closed position and receive the cutter 12 therein, the first cover body 210, the cutter 12 and the second cover body 220 are arranged sequentially along the first direction, such configuration can be called a state where the working part is covered in place.

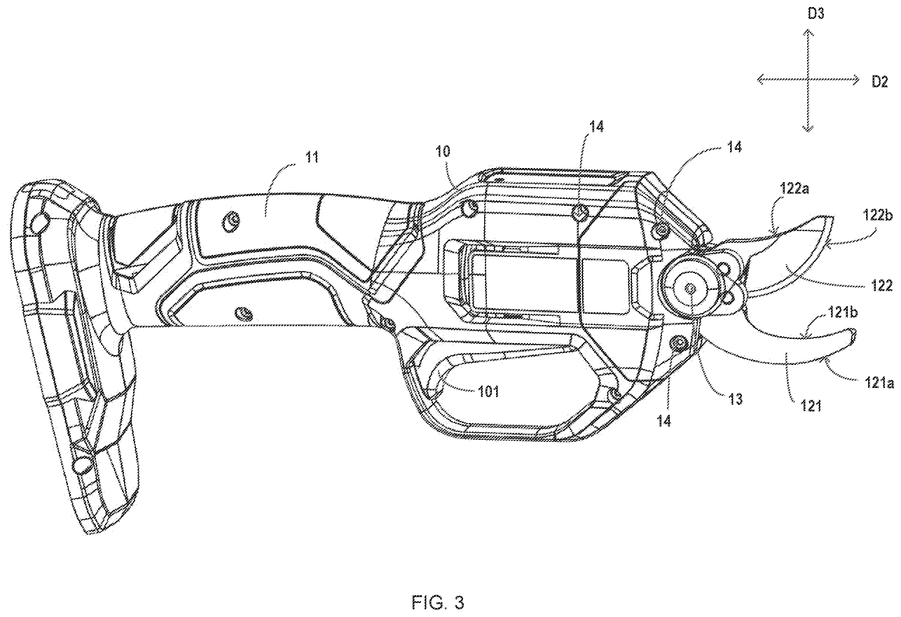

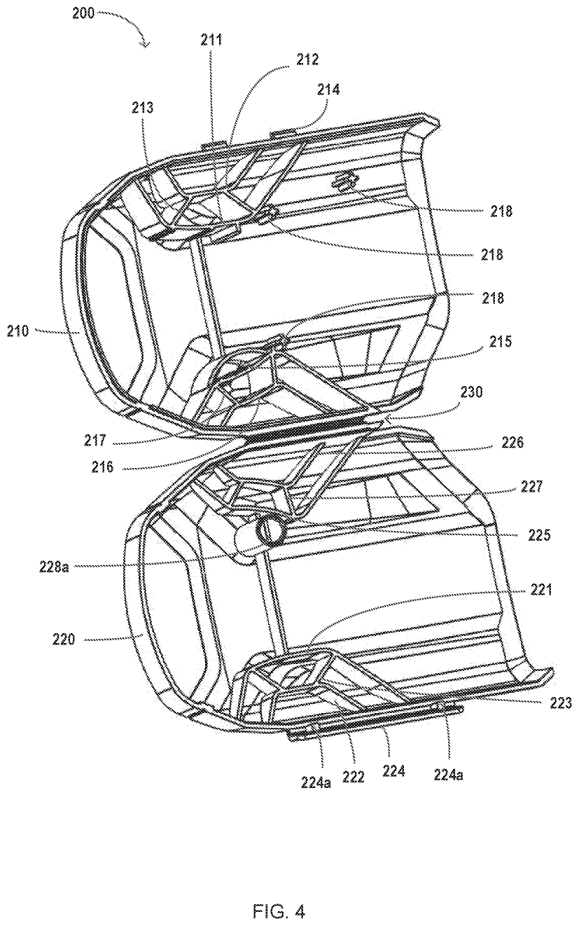

Continuing with FIGS. 3 and 4, on an outer sidewall of the tool body 10 is provided with a recessed hole 14, and an inner sidewall of the first cover body 210 is formed with a pin 218 configured to be inserted into the recessed hole 14 such that the protecting cover is removably fixed on the tool body 10, and the cutter 12 is received in the receiving space of the protecting cover. More specifically, the pin 218 can extend in the first direction. Alternatively, it is also feasible that an inner sidewall of the first cover body 210 is provided with a recessed hole while the tool body is provided with a pin for mating therewith.

The recessed hole 14 on the tool body 10 and the pin 218 on the first cover body 210 may be arranged in multiple fashions. For example, as can be seen from FIG. 4, the projection of the pin 218 on the feature plane or the section of the pin 218 may be of a cross-shape. In other implementations, the projection of the pin 218 on the feature plane or the section of the pin 218 may be of other shapes. The recessed hole 14 on the tool body 10 may be a screw hole. More specifically, the tool body 10 includes two housing components assembled together via a screw, where a screw hole on one of the housing components for receiving the screw is opened towards the pin 218 so that the screw hole can also act as the recessed hole 14. Such arrangement does not need an extra recessed hole specially for engaging the pin, thus simplifying the manufacturing process and having less damage to the integrity of the outer structure of the tool body 10. This mating structure according to the present utility model is not only simple but also convenient since it can simultaneously accomplish positioning in multiple directions.

The cross-shaped pin 218 can be received in the recessed hole 14 with slight interference fit to improve the holding strength. The pin 218 configured in a cross shape is not only advantageous for achieving the interference fit effect, but also can save material and lower the cost as compared with a cylindrical pin 218.

Preferably, referring further to FIGS. 1 and 4, the inner sidewall of at least one of the first cover body 210 and the second cover body 220 is provided with a rib, and an outer contour of the rib within the plane (i.e., the feature plane mentioned above) perpendicular to the first direction form-fits with an outer contour of the cutter 12, to prevent releasing of the working part from the protecting cover. When the working part is covered, the rib and cutter may slightly interfere with each other to form a tight fit so that static friction is generated between the rib and the cutter 12 to prevent releasing of the cutter 12 from the first cover body 210 and the second cover body 220 along the first direction.

In the implementation, the first cover body 210 and the second cover body 220 are each provided with two ribs that are positioned on two sides of the cutter 12 in the third direction D3.

Returning to FIGS. 2 and 3, it can be seen that the cutter 12 in the implementation includes a stationary blade 121 and a movable blade 122 that are configured to pivot relative to each other about a pivot 13 within the feature plane, thus forming a scissor structure. The stationary blade 121 is fixed relative to the tool body 10, the movable blade 122 is pivotable relative to the stationary blade 121 between a first limit position and a second limit position, and the power tool 100 is configured to retain the movable blade 122 in the first limit position when the operation is stopped. The first limit position may be a position where the movable blade 122 farthest away from the stationary blade 121. For example, the movable blade 122 as shown in FIGS. 1 and 3 is located in the first limit position.

Corresponding to the cutter 12 having the above structure, the rib of the first cover body 210 may include: a first rib 215 mating with a stationary blade feature outer contour 121a (which is opposite to the blade edge 121b of the stationary blade 121) of the stationary blade 121 away from the movable blade 122, and a second rib 211 mating with a movable blade feature outer contour 122a (which is opposite to the blade edge 122b of the movable blade 122) of the movable blade 122 away from the stationary blade 121. Further, the second rib 211 is positioned to mate with the movable blade feature outer contour 122a of the movable blade 122 located in the first limit position. Still further, continuing with FIGS. 1 and 3, the stationary blade feature outer contour 121a is an arc contour convex along the feature plane while the movable blade feature outer contour 122a is an arc contour concave along the feature plane. Correspondingly, the portion of the first rib 215 contacting the stationary blade 121 is slightly concave while the portion of the second rib 211 contacting the movable blade 122 slightly convex.

Likewise, the rib of the second cover body 220 may include a first rib 225 and a second rib 221. Although the respective ribs of the first cover body 210 and the second cover body 220 are arranged correspondingly in this implementation, it is feasible in practice that only the ribs of the first cover body 210 abut against the stationary blade 121 and the movable blade 122. In other implementations not shown, ribs for abutting against and mating with the cutter 12 may be disposed on only one of the first cover body and the second cover body, or the first cover body 210 is provided with a rib abutting against the stationary blade while the second cover body is provided with a rib abutting against the blade.

In other implementations not shown, the power tool 100 may be configured to retain the movable blade 122 in a position closest to the stationary blade 121 when the operation is stopped, and the respective ribs of the first cover body 210 and/or the second cover body 220 may be configured to mate with the movable blade 122 in this position.

Referring to FIGS. 1 and 4, an outer side of the first rib 217 of the first cover body 210 along the third direction D3 is provided with a first reinforcing rib 216 of the first cover body 210 in form fit with the first rib 217 of the first cover body 210, and between the first rib 217 of the first cover body 210 and the first reinforcing rib 216 of the first cover body 210 is disposed a first connecting rib position 217 of the first cover body 210. The combination of the first rib 217, the first reinforcing rib 216 and the first connecting rib position 217 of the first cover body 210 can reinforce the intensity of the first cover body 210 to thus guarantee long-term use of the first cover body 210 without deformation.

Similarly, an outer side of the second rib 211 of the first cover body 210 along the third direction D3 is further provided with a second reinforcing rib 212 of the first cover body 210 in form fit with the second rib 211 of the first cover body 210, and between the second rib 211 of the first cover body 210 and the second reinforcing rib 212 of the first cover body 210 is disposed a second connecting rib position 213 of the first cover body 210; an outer side of the first rib 225 of the second cover body 220 along the third direction D3 is further provided with a first reinforcing rib 226 of the second cover body 220 in form fit with the first rib 225 of the second cover body 220, and between the first rib 225 of the second cover body 220 and the first reinforcing rib 226 of the second cover body 220 is disposed a first connecting rib position 227 of the second cover body 220; an outer side of the second rib 221 of the second cover body 220 along the third direction D3 is further provided with a second reinforcing rib 222 of the second cover body 220 in form fit with the second rib 221 of the second cover body 220, and between the second rib 221 of the second cover body 220 and the second reinforcing rib 222 of the second cover body 220 is disposed a second connecting rib position 223 of the second cover body 220.

In addition to the mating between the pin 218 and the recessed hole 14 and the mating between the ribs and the cutter 12 as stated above, the protecting cover may be provided with other structures, for example, a magnet, for retaining itself on the tool body 10. As shown in FIGS. 1 and 4, the inner sidewall of the second cover body 220 is fixed with a magnet 228 protruding towards the cutter 12. The magnet 228 is positioned in such a manner that, when the protecting cover covers the cutter in place, the magnet 228 is attached to the cutter 12, specifically to a predetermined position on the stationary blade 121. FIG. 4 shows a slot 228a disposed on the second cover body 220, for receiving the magnet 228.

The protecting cover according to the present implementation can receive tool accessories in addition to the cutter 12. For example, the power tool 100 is configured to allow a user to remove or replace the cutter using tool accessories, and the receiving space further includes a space for receiving tool accessories, for example, a space inside the ribs for receiving tool accessories.

In the present implementation, a retaining member is provided at an end of the first cover body 210 and/or the second cover body 220 away from a pivot connection position 230, the retaining member being configured to retain the first cover body 210 and the second cover body 210 at the closed position. The retaining member may be a locking mechanism. For example, the retaining member includes a protrusion 214 disposed on one end of the first cover body 210 opposite to the connection position along the third direction D3, and a hook portion 224 disposed on an end of the second cover body 220 opposite to the connection position along the third direction D3, where the hook portion 224 includes a plurality of hooks 224a configured to engage the protrusion 214.

In the present implementation, the engagement mechanisms include a combination of a pin and a recessed hole. However, in other implementations not shown, the engagement mechanisms may include other structures that can be fixed relative to each other.

According to the present utility model, there is further provided a protecting cover that can be manufactured and sold independently of the tool body. The description related to the protecting cover in the above implementation should be considered as an implementation of the protecting cover according to the present utility model.

The protecting cover according to the present utility model can be easily and conveniently installed on the body of the power tool, and there may be multiple connection relations between the protecting cover and the tool body to enable them to be fixed relative to each other so that the protecting cover and the tool body, particularly the cutter, in an installed state can engage firmly and conveniently and prevent releasing of the protecting cover. In addition, the protecting cover according to the present utility model per se has high intensity, which is not prone to deformation after long-term use. Further, the protecting cover can receive therein accessories for replacing the cutter to thus provide more convenience to the user.

The above description on multiple implementations of the present utility model is provided to the ordinary skilled in the related field for the purpose of illustration, without any intention to make the present utility model exclusive or confine the same to a single implementation disclosed here. As aforementioned, the ordinary skilled in the art would understand that multiple replacements and variations of the present utility model are also applicable. Therefore, although some alternative implementations are described here in detail, the ordinary skilled in the art would easily envision or design other implementations. The present utility model is intended to cover all the replacements, modifications and variations of the present utility model, and other implementations falling into the spirits and scope described here.

1. A power tool, the power tool comprising:
a tool body provided with a working part protruding outwards;
a protecting cover comprising a first cover body and a second cover body, the first cover body and the second cover body being pivotably connected to enable movement between an open position and a closed position, the first cover body and the second cover body jointly defining a receiving space for receiving the working part when being in the closed position, and a retaining member being provided at an end of the first cover body and the second cover body away from a pivot connection position, the retaining member being configured to retain the first cover body and the second cover body in the closed position,
wherein engagement mechanisms are formed on an outer sidewall of the tool body and an inner sidewall of the first cover body, the engagement mechanisms being configured to mate with each other and to enable the protecting cover to be removably fixed on the tool body.

2. The power tool of claim 1, wherein the engagement mechanisms comprise a pin disposed on one of the inner sidewall of the first cover body and the outer sidewall of the tool body, and a recessed hole disposed on the other one of the inner sidewall of the first cover body and the outer sidewall of the tool body.

3. The power tool of claim 1, wherein the engagement mechanisms comprise a pin disposed on the inner sidewall of the first cover body and a recessed hole on the outer sidewall of the tool body, wherein:
the pin has a cross-shaped section;
the tool body comprises at least two housing components assembled together via a screw, and a screw hole on one of the housing components for receiving the screw also acts as the recessed hole.

4. The power tool of claim 1, wherein an inner sidewall of at least one of the first cover body and the second cover body is provided with a rib, and an outer contour of the rib and an outer contour of the working part at least partly form-fit so that the rib prevents the working part from being released from the protecting cover when the protecting cover is in place to cover the working part.

5. The power tool of claim 4, wherein the rib comprises a first rib and a second rib disposed opposite to each other, and the working part is a cutter comprising a stationary blade and a movable blade pivotable relative to the stationary blade, a stationary blade feature outer contour of the stationary blade away from the movable blade is partly form-fit with the first rib, and a movable blade feature outer contour of the movable blade away from the stationary blade is partly form-fit with the second rib.

6. The power tool of claim 5, wherein the stationary blade feature outer contour is a convex arc contour, and the movable blade feature contour is a concave arc contour.

7. The power tool of claim 5, wherein the stationary blade is fixed relative to the tool body, the movable blade is pivotable relative to the stationary blade between a first limit position and a second limit position, and the power tool is configured to retain the movable blade in the first limit position when operation is stopped, and the second rib is positioned to mate with the movable blade feature outer contour when the movable blade is in the first limit position.

8. The power tool of claim 1, wherein the power tool is configured to allow a user to remove and replace the working part using tool accessories, and the receiving space further comprises a space for receiving the tool accessories.

9. The power tool of claim 1, wherein an inner sidewall of the second cover body is provided with a magnet protruding towards the working part, and the magnet is positioned in such a manner that the magnet is attached to the working part when the protecting cover is in place to cover the working part.

10. The power tool of claim 1, wherein the retaining member comprises locking mechanisms mating with each other and respectively disposed on the first cover body and the second cover body.

11. A protecting cover of a power tool, the power tool comprising a tool body having a working part protruding outwards, wherein the protecting cover comprises a first cover body and a second cover body that are pivotably connected to enable movement between an open position and a closed position, and the first cover body and the second cover body jointly define a receiving space for receiving the working part when being in the closed position, and a retaining member is provided at an end of the first cover body and the second cover body away from a pivot connection position, the retaining member being configured to retain the first cover body and the second cover body in the closed position,
wherein an inner sidewall of the first cover body is provided with an engagement mechanism for engaging an outer sidewall of the tool body, the engagement mechanism being configured to enable the protecting cover to be removably fixed on the tool body.

12. The protecting cover of claim 11, wherein the engagement mechanism comprises a pin.

13. The protecting cover of claim 11, wherein the pin has a cross-shaped section.

14. The protecting cover of claim 11, wherein an inner sidewall of at least one of the first cover body and the second cover body is provided with a rib, and an outer contour of the rib and an outer contour of the working part at least partly form-fit to prevent the working part from being released from the protecting cover when the protecting cover is in place to cover the working part.

15. The protecting cover of claim 14, wherein the rib comprises a first rib and a second rib that at least partly form-fit with the working part, respectively.

16. The protecting cover of claim 11, wherein the receiving space further comprises a space for receiving tool accessories for removing and replacing the working part.

17. The protecting cover of claim 11, wherein an inner sidewall of the second cover body is provided with a protruding magnet that is positioned in such a manner that the magnet is attached to the working part when the protecting cover is in place to cover the working part.

18. The protecting cover of claim 11, wherein the retaining member includes locking mechanisms mating with each other and respectively disposed on the first cover body and the second cover body.
